(19) United States
(12) Patent Application Publication
(10) Pub. No.: US 2010/0049915 A1
(43) Pub. Date: Feb. 25, 2010

(54) Virtual disk timesharing

(76) Inventors: Todd R. Burkey, Savage, MN (US); James Lorenzen, Minnetonka, MN (US)

Correspondence Address: BECK AND TYSVER P.L.L.C., 2900 THOMAS AVENUE SOUTH, SUITE 100, MINNEAPOLIS, MN, 55416, US

(21) Appl. No.: 12/229,151

(22) Filed: Aug. 20, 2008

(51) Int. Cl. G06F 12/08

(52) U.S. Cl. 711/114; 711/E12.019

(57) ABSTRACT

A method and system are described for the use of a high speed storage device to temporarily substitute for a low speed storage device in a computer storage system. Because the change is done behind a virtualization facade, hot swapping of the storage devices is achieved. A record is kept of changes to the high speed storage device during the substitution interval, to update the low speed storage device so that it can resume its responsibilities. The resumption of responsibilities by the low speed storage device is also achieved by hot swapping. The approach makes effective use of a relatively rare resource in the storage system, permitting it to be shared among various applications, as directed by a timesharing engine.

### FIELD OF THE INVENTION

The invention pertains to computer storage systems. In particular, the invention pertains to temporarily hot swapping a high speed storage device for a low speed storage device, so that the high speed storage device assumes responsibilities for input/output (IO) operations from the low speed storage device, under direction of a timesharing engine.

### BACKGROUND OF THE INVENTION

Storage virtualization inserts a logical abstraction layer or facade between one or more computer systems and one or more physical storage devices. Virtualization permits a computer to address storage through a virtual disk (VDisk), which responds to the computer as if it were a physical disk (PDisk). Unless otherwise specified in context, we will use the abbreviation PDisk herein to represent any digital physical data storage device, such as conventional rotational media drives, Solid State Drives (SSDs) and magnetic tapes. A VDisk may be implemented using a plurality of physical storage devices, configured through a virtualization scheme in relationships that provide redundancy and improve performance.

Virtualization is often performed within a storage area network (SAN), allowing a pool of storage devices with a storage system to be shared by a number of host computers. Hosts are computers running application software, such as software that performs input and/or output (IO) operations using a database. Connectivity of devices within many modern SANs is implemented using Fibre Channel technology, although many other types of communications or networking technology are available. Ideally, virtualization is implemented in a way that minimizes manual configuration of the relationship between the logical representation of the storage as one or more VDisks, and the implementation of the storage using PDisks and/or other VDisks. Tasks such as backing up, adding a new PDisk, and handling failover in the case of an error condition should be handled by a SAN with little or no need for manual intervention.

In effect, a VDisk is a facade that allows a set of PDisks and/or VDisks, or more generally a set of portions of such storage devices, to imitate a single PDisk. Hosts access the VDisk through a virtualization interface, or facade. Virtualization techniques for configuring the storage devices behind the VDisk facade can improve performance and reliability compared to the more traditional approach that uses a PDisk directly connected to a single computer system. Standard virtualization relationships include mirroring, striping, concatenation, and writing parity information.

Mirroring involves maintaining two or more separate copies of data on storage devices. Strictly speaking, a mirroring relationship maintains copies of the contents/data within an extent, either a real extent or a virtual extent. The copies are maintained on an ongoing basis over a period of time. During that time, the data within the mirrored extent might change. When we say herein that data is being mirrored, it should be understood to mean that an extent containing data is being mirrored, while the content itself might be changing.

Typically, the mirroring copies are located on distinct storage devices that, for purposes of security or disaster recover, are sometimes remote from each other, in different areas of a building, different buildings, or different cities. Mirroring provides redundancy. If a device containing one copy, or a portion of a copy, suffers a failure of functionality (e.g., a mechanical or electrical problem), then that device can be serviced or removed while one or more of the other copies is used to provide storage and access to existing data. Mirroring can also be used to improve read performance. Given copies of data on drives A and B, then a read request can be satisfied by reading, in parallel, a portion of the data from A and a different portion of the data from B. Alternatively, a read request can be sent to both A and B. The request is satisfied from either A or B, whichever returns the required data first. If A returns the data first then the request to B can be cancelled, or the request to B can be allowed to proceed, but the results will be ignored. Mirroring can be performed synchronously or asynchronously. Mirroring can degrade write performance, since a write to create or update two copies of data is not completed until the slower of the two individual write operations has completed.

Striping involves splitting data into smaller pieces, called “stripes.” Sequential stripes are written to separate storage devices, in a round-robin fashion. For example, suppose a file or dataset were regarded as consisting of six contiguous extents of equal size, numbered 1 to 6. Striping these extents across three drives would typically be implemented with parts 1 and 4 as stripes on the first drive; parts 2 and 5 as stripes on the second drive; and parts 3 and 6 as stripes on the third drive. The stripes, in effect, form layers, called “strips” within the drives to which striping occurs. In the previous example, stripes 1, 2, and 3 form the first strip; and stripes 4, 5, and 6, the second. Striping can improve performance on conventional rotational media drives because data does not need to be written sequentially by a single drive, but instead can be written in parallel by several drives. In the example just described, stripes 1, 2, and 3 could be written in parallel. Striping can reduce reliability, however, because failure of any one of the storage devices holding a stripe will render unrecoverable the data in the entire copy that includes the stripe. To avoid this, striping and mirroring are often combined.

Writing of parity information is an alternative to mirroring for recovery of data upon failure. In parity redundancy, redundant data is typically calculated from several areas (e.g., 2, 4, or 8 different areas) of the storage system and then stored in one area of the storage system. The size of the redundant storage area is less than the remaining storage area used to store the original data.

A Redundant Array of Independent (or Inexpensive) Disks (RAID) describes several levels of storage architectures that employ the above techniques. For example, a RAID 0 architecture is a striped disk array that is configured without any redundancy. Since RAID 0 is not a redundant architecture, it is often omitted from a discussion of RAID systems. A RAID 1 architecture involves storage disks configured according to mirror redundancy. Original data is stored on one set of disks and duplicate copies of the data are maintained on separate disks. Conventionally, a RAID 1 configuration has an extent that fills all the disks involved in the mirroring. An extent is a set of consecutively addressed storage units. (A storage unit is the smallest unit of storage within a computer system, typically a byte or a word.) In practice, mirroring sometimes only utilizes a fraction of a disk, such as a single partition, with the remainder being used for other purposes. Also, mirrored copies might themselves be RAIDs or VDisks. The RAID 2 through RAID 5 architectures each involves parity-type redundant storage. RAID 10 is simply a combination of RAID 0 (striping) and RAID 1 (mirroring). This RAID type allows a single array to be striped over more than two physical disks with the mirrored stripes also striped over all the physical disks.

Concatenation involves combining two or more disks, or disk partitions, so that the combination behaves as if it were a single disk. Not explicitly part of the RAID levels, concatenation is a virtualization technique to increase storage capacity behind the VDisk facade.

Virtualization can be implemented in any of three storage system levels—in the hosts, in the storage devices, or in a network device operating as an intermediary between hosts and storage devices. Each of these approaches has pros and cons that are well known to practitioners of the art.

Various types of storage devices are used in current data processing systems. A typical system may include one or more large capacity tape units and/or disk drives (magnetic, optical, or semiconductor) connected to the systems through respective control units for storing data. Virtualization, implemented in whole or in part as one or more RAIDs, is an excellent method for providing high speed, reliable data storage and file serving, which are essential for any large computer system.

A VDisk is usually represented to the host by the storage system as a logical unit number (LUN) or as a mass storage device. Often, a VDisk is simply the logical combination of one or more RAIDs.

Because a VDisk emulates the behavior of a PDisk, virtualization can be done hierarchically. For example, a VDisk containing two 200 gigabyte (200 GB) RAID 5 arrays might be mirrored to a VDisk that contains one 400 GB RAID 10 array. More generally, each of two VDisks that are virtual copies of each other might have very different configurations in terms of the numbers of PDisks, and the relationships being maintained, such as mirroring, striping, concatenation, and parity. Striping, mirroring, and concatenation can be applied to VDisks as well as PDisks. A virtualization configuration of a VDisk can itself contain other VDisks internally. Copying one VDisk to another is often an early step in establishing a VDisk mirror relationship. A RAID can be nested within a VDisk or another RAID; a VDisk can be nested in a RAID or another VDisk.

Solid state drives (SSDs), sometimes called solid state disks, are a major advance in storage system technology. An SSD is a data storage device that uses non-volatile memory such as flash, or volatile memory, such as SDRAM, to store data. The SSD can replace a conventional rotational media hard drive (RMD), which has spinning platters. There are a number of advantages of SSDs in comparison to traditional RMDs, including much faster read and write times, better mechanical reliability, much greater IO capacity, an extremely low latency, and zero seek time. A typical RMD may have an input/output (IO) capacity of 200 random IO operations per second, while a typical DRAM SSD may have an IO capacity of 20,000 random IOs per second. This speed improvement of nominally two orders of magnitude is offset, however, by a cost of SSD storage that, at today's prices, is roughly two orders of magnitude higher than RMD storage.

Typically, a storage system is managed by logic, implemented by some combination of hardware and software. We will refer to this logic as a controller of the storage system. A controller typically implements the VDisk facade and represents it to whatever device is accessing data through the facade, such as a host or application server. Controller logic may reside in a single device or be dispersed over a plurality of devices. A storage system has at least one controller, but it might have more. Two or more controllers, either within the same storage system or different ones, may collaborate or cooperate with each other.

### SUMMARY OF THE INVENTION

The inventor has recognized that if a given storage device is relatively fast, but relatively expensive, compared to other storage devices in a storage system, it can be effectively used as a shared resource. In particular, a fast storage device can be used on an as needed basis to alleviate load on other devices in the storage system, or to speed up the execution of particular applications.

In today's technology, examples of such devices include an SSD, a high speed RMD, a VDisk or RAID of RMDs that takes advantage of striping to improve read and write performance, and a VDisk or RAID of RMDs that takes advantage of mirroring to improve read performance. We will refer to such a fast, expensive, digital storage device as a high speed storage device (HSSD), and a slow, inexpensive, device as a low speed storage device (LSSD).

The reader will recognize that “fast” and “slow” are relative terms, as are “expensive” and “inexpensive”. Also, whether a device is fast or slow may depend upon the particular task to which it is being applied. A particular device might be relatively fast for reading but slow for writing (e.g., a RAID 1 mirror pair). For all these reasons, an HSSD in one context could be a LSSD in another.

To take advantage of a HSSD as a shared resource, the invention provides a transfer process to allow the HSSD to assume the responsibilities of the LSSD within the storage system. Such assumption of responsibilities might include some or all of the following steps: (1) determining that a transfer of responsibility from the LSSD to the HSSD should occur, and when it should occur; (2) transferring data from the LSSD to the HSSD; (3) routing new IO requests to the HSSD; (4) providing mirroring redundancy for the HSSD; (5) determining that a transfer of responsibility from the HSSD to the LSSD should occur, and when it should occur; and (6) routing new IO requests to the LSSD. The HSSD can be hot swapped for the LSSD, without interruption of service to hosts accessing the storage system, the hosts being unaware of the change; similarly, when responsibility for IO processing is returned from the HSSD to the LSSD.

The decision whether to make a transfer of responsibility, and when a particular transfer should be carried out, may be done by a timesharing engine that is implemented in logic. The timesharing engine may take into account one or more of the following factors in its decision making: scheduling of the storage devices; priorities assigned to particular tasks or hosts; information about other tasks that are queued for a high speed device; information about a job currently running on the high speed device; a request or hint from a system administrator; the expected duration of a task wanting the high speed storage device; recognized patterns of events in the storage system; predictions of load on storage devices; availability of a second high speed storage device to mirror the one assuming responsibility for IO operations; and measurements of storage load.

In some embodiments of the invention, the HSSD initially has a mirroring relationship with the LSSD. Breaking that relationship allows write requests to be handled more quickly by the HSSD alone. In other embodiments, the HSSD substitutes for the LSSD without such a prior mirroring relationship. In any case, a second HSSD may optionally be used to mirror the first HSSD during the high speed IO interval, to provide redundancy. As needed, the second HSSD could take over IO handling from the first HSSD, again without interruption of availability of the virtual disk for IO operations.

The invention also provides a transfer system, which includes an LSSD and a HSSD, to allow the HSSD to assume the responsibilities of the LSSD within the storage system. The transfer system includes logic to perform some or all of the steps of the transfer process. The logic might be in software executed by a processor, or in digital hardware, or some combination thereof. The logic might be contained in a single device, or spread over multiple devices. For example, a controller might need to read from a storage device to retrieve instructions to be run upon a processor to carry out the process. It might be contained within a host, within a SAN, or within a particular storage device or storage array. Typically, the logic will be found in a controller for the storage system.

### BRIEF DESCRIPTION OF THE DRAWINGS

FIG. 1 is a block diagram of a storage system in an embodiment of the invention.

FIG. 2 is a block diagram of a storage system, illustrating the temporary relieving by a high speed storage device from a low speed storage device of processing of IO requests.

FIG. 3 is a flowchart illustrating a process whereby a high speed storage device, or pair of high speed storage devices, temporarily takes over processing of IO requests from a low speed storage device.

FIG. 4 is a block diagram of a storage system in an embodiment of the invention, illustrating the temporary breaking of a mirroring relationship between a high speed storage device and a low speed storage device when faster IO processing is needed.

FIG. 5 is a flowchart, illustrating the temporary breaking of a mirroring relationship between a high speed storage device and a low speed storage device, in an embodiment of the invention.

FIG. 6 is a block diagram of a high speed storage device (HSSD) timesharing engine in an embodiment of the invention.

### DETAILED DESCRIPTION OF THE INVENTION

The specific embodiments of this Description are illustrative of the invention, but do not represent the full scope or applicability of the inventive concept. For the sake of clarity, the examples are greatly simplified. Persons of ordinary skill in the art will recognize many generalizations and variations of these embodiments that incorporate the inventive concept.

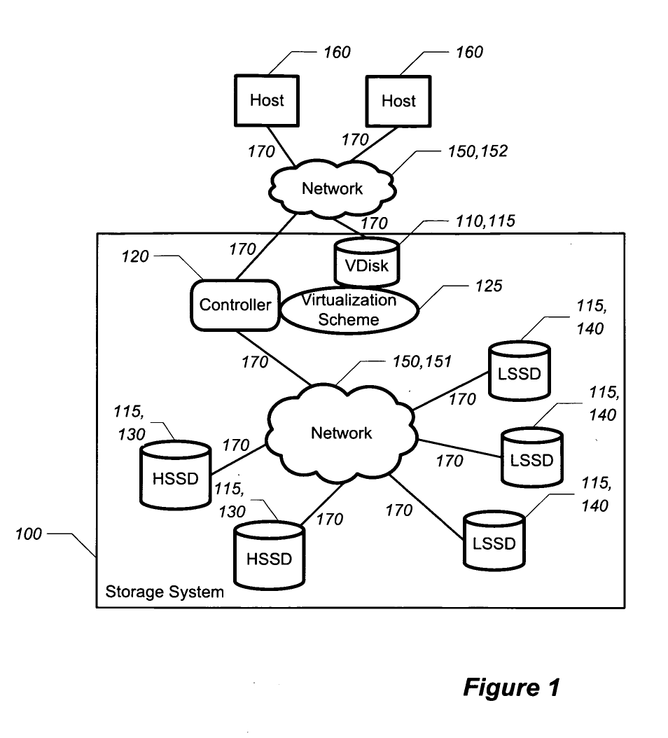

FIG. 1 is a block diagram of a storage system 100 in an embodiment of the invention. The storage system 100 includes a virtual disk (VDisk) 110 that is accessible for IO operations by one or more hosts 160, which are external to the storage system 100. We will refer to such a VDisk 110 as an interface VDisk 110 because it presents an interface to the hosts 160, a facade through which the VDisk 110 responds to IO requests from the hosts as if it were a physical storage device. The storage system 100 includes a plurality of storage devices 115 that are adapted to store data and to respond to IO requests. A storage device 115 may be a physical storage device, or may itself be a VDisk 110. The interface VDisk 110 storage is implemented by storage on other storage devices 115 in the storage system 100.

The relationship between the interface VDisk 110 and the implementing storage devices 115 is described by a virtualization scheme 125 that is managed and maintained by the controller 120. Through the virtualization scheme 125 of the interface VDisk 110 (possibly by way of virtualization schemes 125 nested within a virtualization hierarchy), data stored on the interface VDisk 110 is ultimately stored on physical storage devices. A virtualization scheme 125 may define relationships, such as mirroring, striping, concatenation, and parity checking. The virtualization scheme 125 may describe a RAID.

Components of the storage system 100 communicate through a communication system that is typically a network 150; in this case, a storage system network 151. The hosts 160 also communicate with the VDisk 110 through a communication system, typically a network 150; in this case, an external network 152. Either network 150 may be a wide area network (WAN), a local area network (LAN), or a personal area network (PAN). Many modern networks use Fibre Channel technology. The various elements are communicatively connected to each other through links 170 to the communications systems.

The storage devices 115 in the storage system 100 may perform IO operations at various speeds. A physical storage device may be inherently relatively fast. For example, a solid state drive may be an order of magnitude faster than a conventional rotational media drive. Differences in speed may also be attained by RAID operations, as previously described in the Background section. For example, all else being equal, data in a VDisk 110, the data being striped across several functionally identical rotational media drive, can be read faster than the same data on a single rotational media drive of the same type. Of course, whether a device is relatively fast or relatively slow may depend upon the particular operation being performed, for example, a read operation as opposed to a write operation.

We will assume that the storage system 100 includes a high speed storage device (HSSD) 130 and an low speed storage device (LSSD) 140, where the HSSD 130 is relatively fast compared to the LSSD 140 for the type of operation or operations required by some IO resource “consumer”. In this context, a consumer might be a particular task, a group of tasks, or a host. The particular type(s) of operation may remain unspecified. The HSSD 130 may be a physical storage device or a VDisk 110; similarly, for the LSSD 140.

The needs of hosts 160 for data access to the interface VDisk 110 will typically vary over time. For example, a certain application, which reads and/or writes to a database on the interface VDisk 110, may be run routinely at a particular time of day, month, or year. In a complex storage system available to a variety of hosts for a variety of types of applications, at any given time some storage devices will be experiencing heavier load than other portions. A HSSD 130 will be a particularly useful resource when a consumer requires fast turnaround, or when a portion of the storage system 100 is heavily loaded.

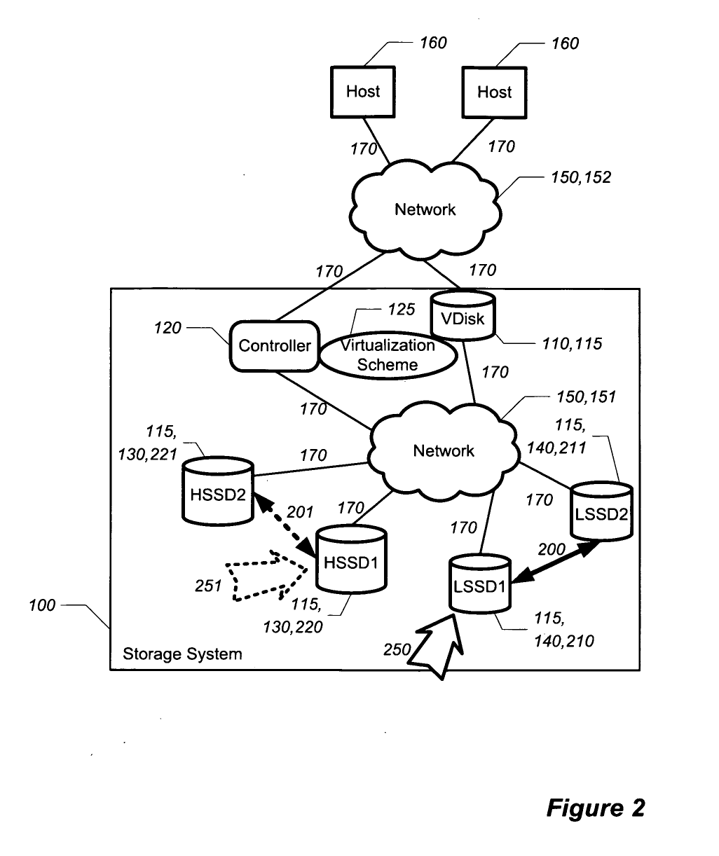

FIG. 2 is a block diagram of a storage system 100, illustrating the temporary relieving by a HSSD 130, namely HSSD1 220, from an LSSD 140, namely LSSD1 210, of processing of IO requests. Such a transfer of responsibility might be useful if a performance advantage could be gained with respect to processing of read requests, write requests, or a combination of read and write requests. Prior to the transfer, a relationship might be maintained during normal operations whereby LSSD1 210 is mirrored by a second LSSD 140, namely LSSD2 211. The mirroring relationship, which is optional, before the transfer of responsibility for IO processing is indicated by a double-ended, solid arrow 200. As indicted in the figure by a single-ended arrow with a solid outline 251, prior to the transfer, IO requests are directed to LSSD1 210, or to the pair of LSSD1 210 and LSSD2 211 if such mirroring relationship exists.

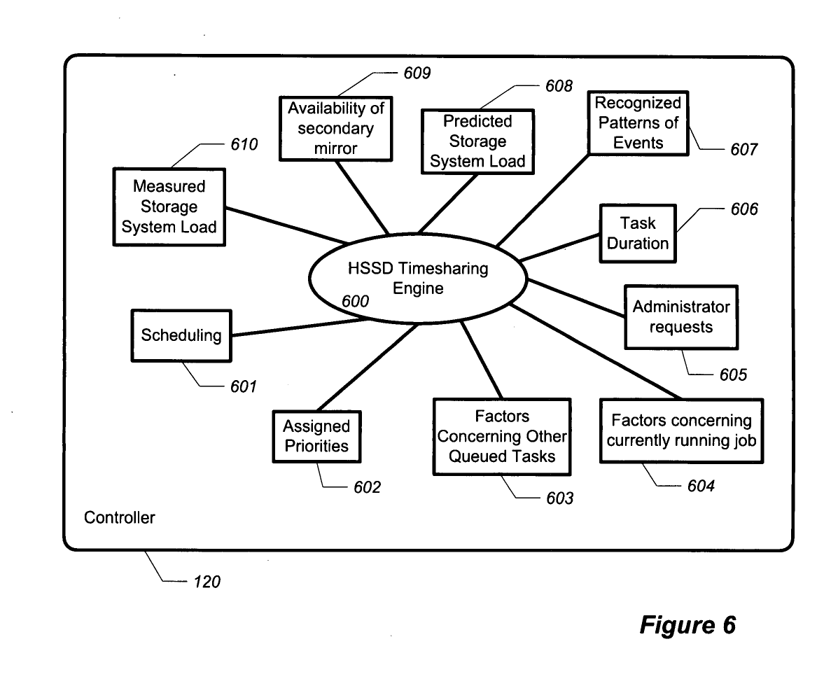

The transfer of responsibility may be implemented by the controller 120, and triggered by a timesharing engine, described below in connection with FIG. 6. Typically, the timesharing engine will be part of the controller logic. A second HSSD 130, namely HSSD2 221, might optionally be used to mirror HSSD1 220 during the high speed processing interval. During that interval, as indicated in the figure by a single-ended arrow with a dashed outline 251, IO requests are directed to HSSD1 220, or to the pair of HSSD1 220 and HSSD2 221 if such mirroring relationship exists. When the high speed IO period is over, controller logic will return the system to the normal IO processing arrangement that existed prior to the transfer. At that point HSSD1 220 and HSSD2 221 are free for other purposes. The transfer of responsibility is done “hot,” VDisk 110 remaining operational and available throughout the whole process. Devices can continue accessing the VDisk 110 through its virtualization interface, without needing to be aware that a change in the virtualization scheme 125 has occurred.

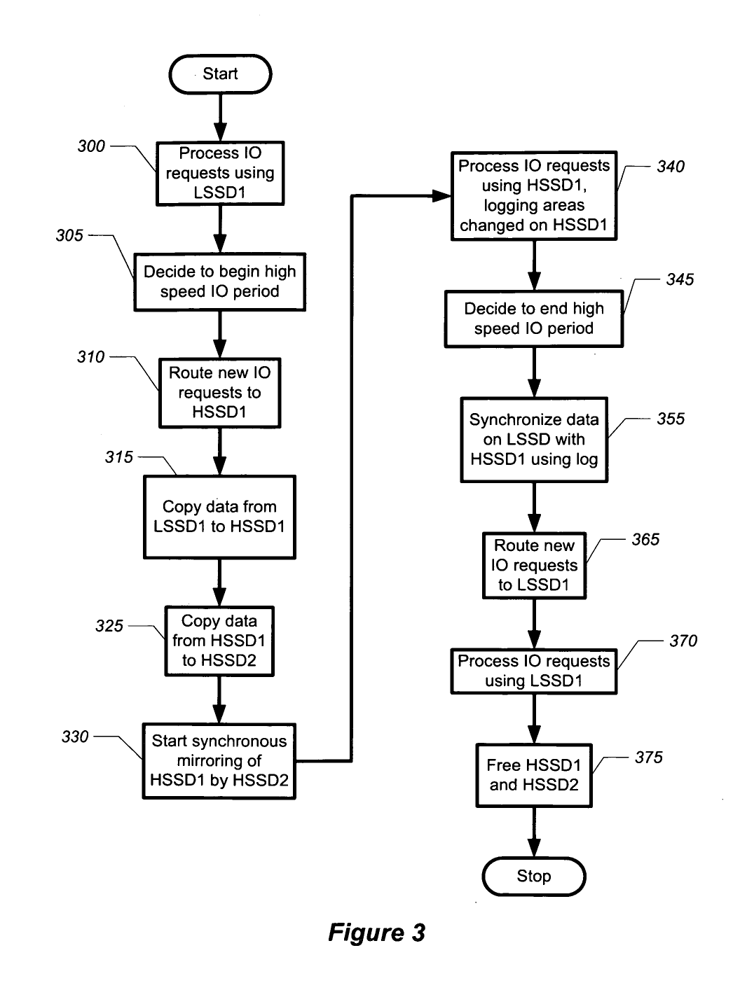

FIG. 3 is a flowchart illustrating the process of temporary transfer of responsibility for IO processing from an LSSD 140 to an HSSD 130, in the storage system 100 that was illustrated by FIG. 2. Initially, IO requests are being processed 300 by LSSD1 210. Alternatively (not shown), IO requests are initially processed by the pair of LSSD1 210 and LSSD2 211, where LSSD2 211 synchronously mirrors LSSD1 210. Logic in the controller 120 determines 305 to use HSSD1 220 to take over IO processing from LSSD1 210. Data is copied 310 from LSSD1 210 to HSSD1 220, so that the contents of HSSD1 220 mirror those of LSSD1 210. New IO requests are routed 315 to HSSD1 220 (or to HSSD2 221). In some embodiments, during the period of transition of IO processing responsibility from LSSD1 210 to HSSD1 220, new IO requests are routed to both LSSD1 210 and HSSD1 220 and processed on both storage devices.

Particularly if write operations will be performed on HSSD1 220, a second HSSD 130, namely HSSD2 221, may be used to mirror HSSD1 220 during the high speed IO period. Such mirroring may be useful even if all the operations will be reads, so that if HSSD1 220 fails then HSSD2 221 will be immediately ready to allow the read operations to continue. However, mirroring to a second HSSD 130 is optional. Assuming HSSD2 221 is used, data is copied 325 from HSSD1 220 to HSSD2 221, so that the contents of HSSD2 221 mirror HSSD1 220. Although the data can be copied to HSSD2 221 from LSSD1 210 instead, this will often be slower than copying from HSSD1 220. Synchronous mirroring is then started 330 by HSSD2 221 of HSSD1 220.

It is a very important point that the LSSD 140 being temporarily replaced by the HSSD 130 may appear anywhere within the virtualization scheme 125 hierarchy for the interface VDisk 110. The temporary assumption by HSSD1 220 of the IO processing responsibilities of LSSD1 210 will be invisible to the hosts 160. This is because the virtualization facade for the interface VDisk 110 that is presented to the hosts 160 by the controller 120 is unchanged throughout the process. In this regard, the situation where LSSD1 210, or a mirroring pair including LSSD1 210 and LSSD2 211, directly implements the virtualization of the interface VDisk 110 is of particular significance.

Also, it should be noted that the invention can also be applied to a VDisk 110 that is internal to the virtualization hierarchy of another VDisk 110. In such embodiments, components of the storage system 100 that access the internal VDisk 110 through its virtualization facade will not be aware of the temporary replacement of LSSD1 210 with HSSD1 220, nor of the swap back of LSSD1 210, replacing HSSD1 220, when the interval of high speed IO ends.

HSSD1 220 processes 340 the IO requests, possibly (but not necessarily) logging any areas that have been changed on HSSD1, relative to LSSD1 210. The logging may be to any tangible medium, such as computer memory or a storage device. The log can have any format, such as a bitmap showing affected drive sectors. The log can be maintained at any logical level of data on HSSD1 220, such as disk sectors or individual bytes.

FIG. 3 goes on to show how responsibility for IO request processing can be returned from HSSD1 220 to LSSD1 210 when the decision is made 345 by the controller 120, or the timesharing engine, to end the period of high speed IO and return to the normal IO processing configuration. Data is synchronized 355 on LSSD1 210 to reflect changes that have been made to HSSD1 220 while the mirroring has been broken. If a log or resynchronization bitmap has been kept, then the recorded changes to HSSD1 220 relative to the LSSD1 210 can be used to achieve synchronization. Otherwise, HSSD1 220 (or HSSD2 221, if the second HSSD 130 was used in mirroring) can be copied in its entirety to LSSD1 210. In some embodiments, new IO requests are routed to both HSSD1 220 and LSSD1 210 (or the pair of LSSD1 210 and LSSD2 211) while the responsibility for IO processing is being transferred back to LSSD1 210. LSSD1 210 then resumes processing 300 of IO requests. At this point, HSSD1 220 (as well as HSSD2 221, if mirroring of HSSD1 has been used during the high speed IO interval) is free 375 for other purposes. The entire process exemplified by FIG. 3, transferring responsibilities for IO operations to and from the HSSD 130, is done hot, without interruption of processing availability or capability of the virtual disk(s) within whose virtualization scheme the swap has occurred.

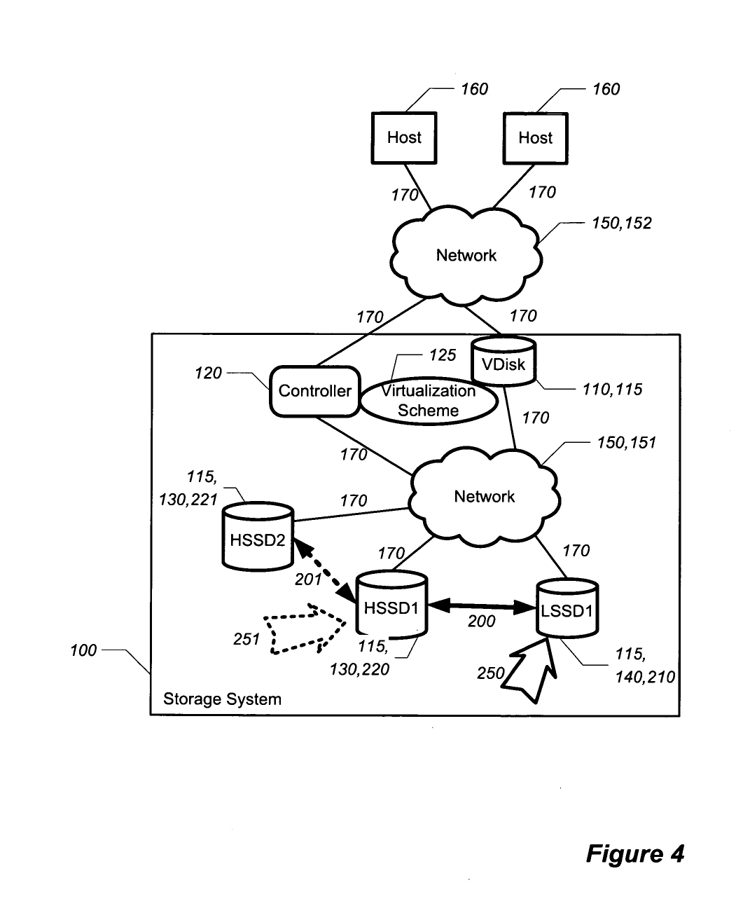

FIG. 4 is a block diagram of a storage system 100 in an embodiment of the invention, illustrating the temporary breaking of an mirroring relationship, which exists between an HSSD 130, namely HSSD1 220 and an LSSD 140, namely LSSD2 211, under normal operations, when faster IO processing is needed. The embodiment illustrated by this figure is particularly relevant when write operations, or a combination of read and write operations, are expected to be performed during the high speed IO processing interval. Since a write operation to a mirrored pair is not complete until it finishes on the slower device, freeing HSSD1 220 from the mirroring relationship with LSSD1 210 can be expected to improve processing speed, possibly dramatically. The mirroring relationship before the transfer of responsibility is shown in the figure with a solid arrow 200. As indicted in the figure by a single-ended arrow with a solid outline 251, prior to the transfer, IO requests are directed to LSSD1 210.

The transfer of responsibility may be implemented by the controller 120, and triggered by a timesharing engine, described below in connection with FIG. 6. Typically, the timesharing engine will be part of the controller logic. A second HSSD 130, namely HSSD2 221, might optionally be used to mirror HSSD1 220 during the high speed processing interval, while the mirroring relationship between HSSD1 220 and LSSD1 210 is severed. During that interval, as indicated in the figure by a single-ended arrow with a dashed outline 251, IO requests are directed to HSSD1 220, or to the pair of HSSD1 220 and HSSD2 221 if such mirroring relationship exists. When the high speed IO period is over, controller logic will return the system to the normal IO processing arrangement that existed prior to the transfer. At that point HSSD1 220 and HSSD2 221 are free for other purposes.

It is a very important point that the pair of HSSD1 220 and LSSD1 210 initially mirroring each other may appear anywhere within the virtualization scheme 125 hierarchy for the interface VDisk 110. The temporary assumption by HSSD1 220 of the IO processing responsibilities of the mirroring pair will be invisible to the hosts 160. This is because the virtualization facade for the interface VDisk 110 that is presented to the hosts 160 by the controller 120 is unchanged throughout the process. In this regard, the situation where the mirroring pair of HSSD1 220 and LSSD1 210 initially directly implements the virtualization of the interface VDisk 110 is of particular significance.

Also, it should be noted that the invention can also be applied to a VDisk 110 that is internal to the virtualization hierarchy of another VDisk 110. In such embodiments, components of the storage system 100 that access the internal VDisk 110 through its virtualization facade will not be aware of the temporary replacement of a mirroring pair of HSSD1 220 and LSSD1 210 with HSSD1 220, nor of the swap back of the mirroring pair, replacing the HSSD 130, when the interval of high speed IO ends.

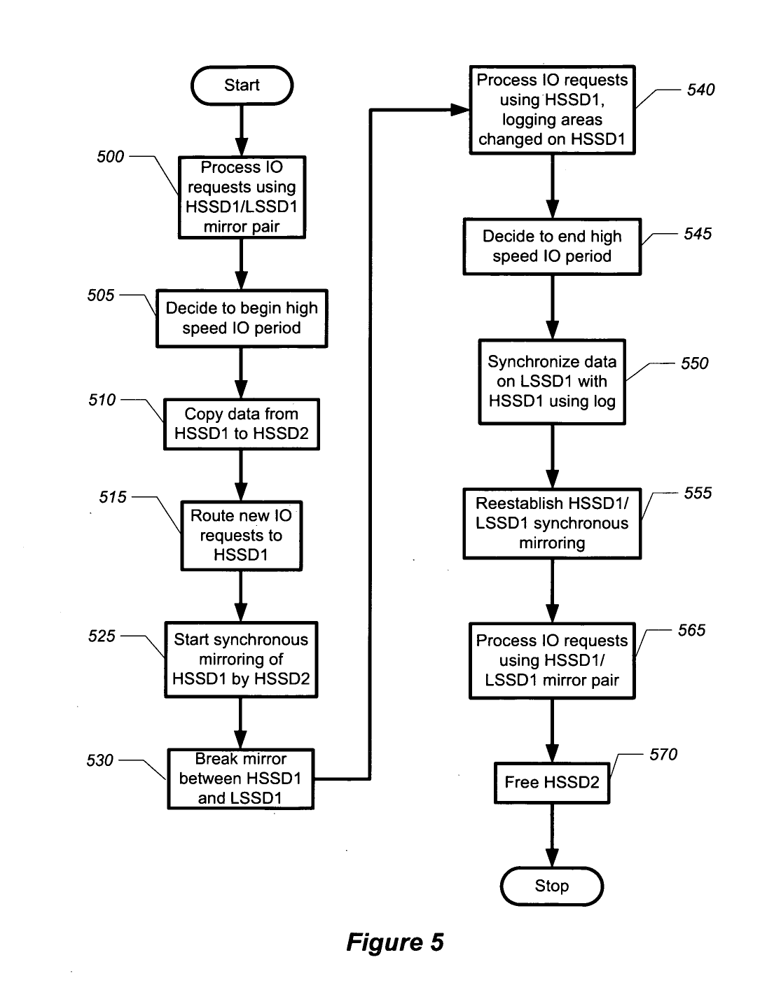

FIG. 5 is a flowchart illustrating the process of temporary transfer of responsibility for IO processing from a pair, including an HSSD 130, namely HSSD1 220, and an LSSD 140, namely LSSD1 210, where LSSD1 210 mirrors HSSD1 220, to just HSSD1 220. The associated storage system 100 was shown in FIG. 4. Initially, IO requests are being handled 500 by the pair of HSSD1 220 and LSSD1 210. Logic in the controller 120 determines to use HSSD1 220 to take over IO processing from the mirroring pair of HSSD1 220 and LSSD1 210. Under normal operations with the mirroring pair, a write operation will only complete when the slower of the two storage devices 115, namely LSSD1 210, finishes writing the data. Logic in the controller 120 determines 505 to use HSSD1 220 to take over IO processing from the mirroring pair of HSSD1 220 and LSSD1 210.

Breaking the mirror allows faster processing, but introduces risk due to lack of redundancy in recording any writes that occur while the mirror is broken. Thus, a second HSSD 130, namely HSSD2 221, may optionally be used to synchronously mirror HSSD1 220 during the temporary high speed processing interval while the mirroring relationship between HSSD1 220 and LSSD1 210 is severed. If so, then the relevant data is copied 510 from HSSD1 220 to HSSD2 221, and synchronous mirroring of HSSD1 220 by HSSD2 221 is begun 525. The mirroring relationship between HSSD1 220 and LSSD1 210 is broken 530. While the mirroring relationship is broken, requests are routed to 515, and processed 540 by, HSSD1 220. If IO requests to the pair were actually being directed to HSSD1 220 anyway, then this step is omitted. The mirror between HSSD1 220 and LSSD1 210 is then broken 530. Requests for IO are processed 540 using HSSD1 220 during the high speed interval, and areas changed on HSSD1 220 are optionally logged.

FIG. 5 goes on to show how responsibility for IO request processing can be returned from HSSD1 220, to the mirroring pair of HSSD1 220 and LSSD1 210, when the decision is made 545 by the controller 120, or the timesharing engine, to end the period of high speed IO and return to the normal IO processing configuration. Data is synchronized 550 onto LSSD1 210 to reflect changes that have been made to HSSD1 220 while the mirroring has been broken. If a log or resynchronization bitmap has been kept, then the recorded changes to HSSD1 220 relative to the LSSD1 210 will be used to achieve synchronization. Otherwise, HSSD1 220 (or HSSD2 221, if the second HSSD 130 was used in mirroring) can be copied in its entirety to LSSD1 210. Synchronous mirroring is reestablished 555 between HSSD1 220 and LSSD1 210. New IO requests are processed by 565 the again mirroring pair of HSSD1 220 and LSSD1 210. At this point, if mirroring of HSSD1 has been used during the high speed IO interval, HSSD2 221 becomes free 375 for other purposes. The entire process exemplified by FIG. 3, transferring responsibilities for IO operations to and from the HSSD 130, is done hot, without interruption of processing availability or capability of the virtual disk(s) within whose virtualization scheme the swap has occurred.

It should be noted that the flowcharts shown in FIG. 3 and FIG. 5 are particular embodiments of the invention. In other embodiments, steps may be followed in a different order, or some steps may be missing. Also, the flowcharts shown in the figures may be split into separate processes within the scope of the invention. For example, in FIG. 3, steps to set up a high speed IO interval (e.g., steps 305 through 340) might be regarded as a separate process from steps to end the high speed IO interval (e.g., steps 345 through 375).

FIG. 6 is a conceptual diagram of a timesharing engine 600 that makes that determination when a high speed processing interval, during which an HSSD 130 temporarily assumes some IO processing responsibilities from an LSSD 140, should begin (e.g., steps 305 and 505) and end (e.g., steps 345 and 545). Ordinarily, the timesharing engine 600 will be part of the controller 120. A HSSD 130 will typically be temporarily assigned to a particular host, a particular task, a particular sequence of tasks, or, generally, to a particular resource.

The timesharing engine 600 might take into account one or more of the factors shown in FIG. 6 in its decision making. In many situations, two factors will be in contention, and should be considered together. The various factors are discussed below.

The interval may be set up by scheduling 601 for an expected high load period. This interval could be regularly scheduled (e.g., daily batch processing), or coincide with a specific event. The decision about which resource to use an HSSD 130, at a particular time, may take into account assigned priorities 602. A variety of tasks may be queued up to use an HSSD 130, so the timesharing engine 600 may consider various factors 603 in deciding whether to select a particular task to which an HSSD 130 will be assigned at a particular time. Factors about the currently running job 604 may be considered in deciding whether that job will continue to use the HSSD 130, or give it up to another one. A specific request or hint from an administrator 605 may be used in allocating an HSSD 130. The duration of a particular task 606 might affect whether it should be given the HSSD 130. Generally, one might expect that a task with a short duration, or one that it is already running and will finish soon, should receive strong consideration.

Logic in the controller might recognize that particular events are, or may be occurring, that could put heavy load onto a particular part of a storage system. That recognition might be because of a recognized sequence of events 607; e.g., heavy load event B always follows event A. Or it might be because a statistical model forecasts 608 heavy load based on a variety of conditions in the system.

Whether it is appropriate to assign an HSSD 130 to a particular resource may depend upon availability of a second HSSD 130 to mirror the first one 609. For example, redundancy of storage of written data may be considered essential. Where to assign an HSSD 130 may depend upon measured load 610 in different parts of the storage system 100.

Embodiments of the present invention in this description are illustrative, and do not limit the scope of the invention. Note that the phrase “such as”, when used in this document, is intended to give examples and not to be limiting upon the invention. It will be apparent other embodiments may have various changes and modifications without departing from the scope and concept of the invention. For example, embodiments of methods might have different orderings from those presented in the flowcharts, and some steps might be omitted or others added. The invention is intended to encompass the following claims and their equivalents.

What is claimed is:

1. A method, comprising:
a) establishing a first virtualization scheme, which associates a virtualization interface of a virtual disk with a plurality of storage devices, a low speed storage device being included in the plurality of storage devices;
b) accepting by a virtual disk, through a virtualization interface, a plurality of requests for IO operations and responding to such requests using the first virtualization scheme, at least one of the IO operations utilizing the low speed storage device;
c) copying data from the low speed storage device to a first high speed storage device;
d) transferring a responsibility for handling requests for IO operations from the low speed storage device to the first high speed storage device, putting a second virtualization scheme into effect that reflects the transferring of the responsibility; and
e) accepting by the virtual disk, through the same virtualization interface, a plurality of requests for IO operations and responding to such requests using the second virtualization scheme, at least one of the IO operations utilizing the first high speed storage device.

2. The method of claim 1, wherein the steps of copying data from the low speed storage device to the first high speed storage device, and transferring the responsibility from the low speed storage device to the first high speed storage device, are carried out hot, without interrupting availability and operation of the virtual disk for IO operations.

3. The method of claim 1, wherein the first high speed storage device is a solid state disk.

4. The method of claim 1, wherein the first high speed storage device is a virtual disk.

5. The method of claim 1, further comprising:
f) determining by a high speed storage device timesharing engine to carry out the step of replacing.

6. The method of claim 5, wherein the timesharing engine considers scheduled events in determining to carry out the step of replacing.

7. The method of claim 5, wherein the timesharing engine considers prediction of storage system load in determining to carry out the step of replacing.

8. The method of claim 1, further comprising:
f) after the transferring a responsibility for handling requests for IO operations from the low speed storage device to the first high speed storage device, creating a synchronous mirroring relationship between the first high speed storage device and a second high speed storage device, the second virtualization scheme including the second high speed storage device and the synchronous mirroring relationship.

9. The method of claim 1, further comprising:
f) maintaining a log of regions on the high speed storage device that change while the second virtualization scheme is in effect.

10. The method of claim 9, further comprising:
g) copying data from regions on the first high speed storage device that the log indicates changed while the second virtualization scheme was in effect to the low speed storage device to the low speed storage device;
h) transferring the responsibility for handling requests for IO operations from the first high speed storage device back to the low speed storage device, putting a third virtualization scheme into effect that reflects the transferring back of the responsibility; and
i) accepting by the virtual disk, through the same virtualization interface, a plurality of requests for IO operations and responding to such requests using the third virtualization scheme, at least one of the IO operations utilizing the low speed storage device.

11. The method of claim 1, wherein the steps of copying data from changed regions on the first high speed storage device to the low speed storage device, and transferring the responsibility from the first high speed storage device back to the low speed storage device, are carried out hot, without interrupting availability and operation of the virtual disk for IO operations.

12. A system, comprising:
a) a virtual disk, including virtualization interface through which the virtual disk is adapted to receive a plurality of requests for IO operations, and to respond to such requests;
b) a plurality of storage devices, including a low speed storage device, that are associated by a virtualization implementation with the virtualization interface and have responsibilities, pursuant to the virtualization scheme, that relate to responding to requests for IO operations;
c) a high speed storage device;
d) logic, tangibly embodied in hardware instructions or in a storage medium as instructions capable of execution by a processor, the logic adapted to
(i) copying data from the low speed storage device to the high speed storage device, and
(ii) transferring responsibilities, pursuant to the virtualization scheme, from the low speed storage device to the high speed storage device, thereby effecting a change to the virtualization implementation,
wherein adaptation of the virtual disk to receive a plurality of requests for IO operations, and to respond to such requests, is unaffected by the change to the virtualization implementation, and wherein the copying and transferring are performed hot, without interrupting availability and operation of the virtual disk for IO operations.

13. A method, comprising:
a) establishing a first virtualization scheme, which associates a virtualization interface of a virtual disk with a plurality of storage devices, the plurality of storage devices including a pair of a first high speed storage device and a low speed storage device, wherein the first high speed storage device and the low speed storage device have a mirroring relationship to each other;
b) accepting by a virtual disk, through a virtualization interface, a plurality of requests for IO operations and responding to such requests using the first virtualization scheme, at least one of the IO operations utilizing the pair;
c) breaking the mirroring relationship between the first high speed storage device and the low speed storage device;
d) transferring a responsibility for handling IO requests from the pair to the first high speed storage device, and putting a second virtualization scheme into effect that reflects the transferring of the responsibility; and
e) accepting by the virtual disk, through the same virtualization interface, a plurality of requests for IO operations and responding to such requests using the second virtualization scheme, at least one of the IO operations utilizing the first high speed storage device.

14. The method of claim 13, wherein the step of transferring the responsibility from the pair to the first high speed storage device, is carried out hot, without interrupting availability and operation of the virtual disk for IO operations.

15. The method of claim 13, wherein the first high speed storage device is a solid state disk.

16. The method of claim 13, wherein the low speed storage device is a virtual disk.

17. The method of claim 13, further comprising:
f) determining by a high speed storage device timesharing engine to carry out the step of replacing.

18. The method of claim 17, wherein the timesharing engine considers scheduled events in determining to carry out the step of replacing.

19. The method of claim 17, wherein the timesharing engine considers prediction of storage system load in determining to carry out the step of replacing.

20. The method of claim 13, further comprising:
f) after the transferring a responsibility for handling requests for IO operations from the pair to the first high speed storage device, creating a synchronous mirroring relationship between the first high speed storage device and a second high speed storage device, the second virtualization scheme including the second high speed storage device and the synchronous mirroring relationship.

21. The method of claim 13, further comprising:
f) maintaining a log of regions on the high speed storage device that change while the second virtualization scheme is in effect.

22. The method of claim 21, further comprising:
g) copying data from regions on the first high speed storage device that the log indicates changed while the second virtualization scheme was in effect to the low speed storage device;
h) transferring the responsibility for handling IO requests from the first high speed storage device back to the pair, and putting a third virtualization scheme into effect that reflects the transferring back of the responsibility; and
i) accepting by the virtual disk, through the same virtualization interface, a plurality of requests for IO operations and responding to such requests using the third virtualization scheme, at least one of the IO operations utilizing the pair.

23. The method of claim 22, wherein the steps of copying data from changed regions on the first high speed storage device to the low speed storage device, and transferring the responsibility from the first high speed storage device back to the pair, are carried out hot, without interrupting availability and operation of the virtual disk for IO operations.

24. A system, comprising:
a) a virtual disk, including virtualization interface through which the virtual disk is adapted to receive a plurality of requests for IO operations, and to respond to such requests;
b) a pair consisting of a high speed storage device and a low speed storage device, the high speed storage device and the low speed storage device having a synchronous mirroring relationship with each other;
c) a plurality of storage devices, including the pair, that are associated by a virtualization implementation with the virtualization interface and have responsibilities, pursuant to the virtualization scheme, that relate to responding to requests for IO operations;
d) logic, tangibly embodied in hardware instructions or in a storage medium as instructions capable of execution by a processor, the logic adapted to
(i) breaking the synchronous mirroring relationship between the low speed storage device to the high speed storage device, and
(ii) transferring responsibilities, pursuant to the virtualization scheme, from the pair to the high speed storage device, thereby effecting a change to the virtualization implementation,
wherein adaptation of the virtual disk to receive a plurality of requests for IO operations, and to respond to such requests, is unaffected by the change to the virtualization implementation, and wherein the copying and transferring are performed hot, without interrupting availability and operation of the virtual disk for IO operations.
